(19) United States
(12) Patent Application Publication
(10) Pub. No.: US 2015/0131783 A1
(43) Pub. Date: May 14, 2015

(54) RADIATION DETECTION SYSTEM AND RADIATION IMAGING APPARATUS

(71) Applicant: CANON KABUSHIKI KAISHA, Tokyo (JP)

(72) Inventor: Genta Sato, Kawasaki-shi (JP)

(21) Appl. No.: 14/527,996

(22) Filed: Oct. 30, 2014

(30) Foreign Application Priority Data
Nov. 12, 2013 (JP) 2013-234138
Oct. 21, 2014 (JP) 2014-214576

(51) Int. Cl. G01T 1/29; G01N 23/20

(52) U.S. Cl. CPC G01T 1/2914; G01N 23/20091
USPC 378/82; 250/394

(57) ABSTRACT

A radiation detection system comprises at least one detector in which a plurality of detection elements are arranged, wherein each detection element includes a converting portion that converts energy of incident radiations directly into electrical signals and a signal reading portion that reads the electrical signal from the converting portion and outputs the electrical signal, the converting portion including a plurality of protruded portions arranged at intervals, and the plurality of protruded portions are electrically connected to one signal reading portion.

### BACKGROUND OF THE INVENTION

1. Field of the Invention

The present invention relates to a radiation detection system.

2. Description of the Related Art

Imaging apparatuses which use radiations including X-rays are used for many purposes in medial diagnosis and non-destructive inspection. In recent years, various attempts have been made to image a change in intensity pattern of radiations, depending on the presence or absence of a subject, thereby acquiring information such as absorption intensity of the subject, phase modulation, and scattering intensity of the subject on the basis of image processing. For example, a method of detecting an interference pattern generated by an interferometer which uses an X-ray diffraction grating is also known. In some case, the period of these intensity patterns is smaller than a resolution (pixel size) of a general radiation detector. In this case, a method of disposing an analyzer grating having approximately the same period as the intensity pattern in front of the detector to generate moire using the intensity pattern and the analyzer grating to thereby increase the period of the intensity pattern is often used.

When radiations having high transmissivity such as X-rays are used, the analyzer grating requires a high aspect ratio. Thus, it is difficult to manufacture the analyzer grating. Therefore, a detector capable of directly detecting an intensity pattern without using the analyzer grating is desired. Japanese Patent Application laid-open No. 2007-203063 (hereinafter called “PTL1”) proposes a method of improving apparent resolution of a detector by classifying a plurality of detection strips provided in one detection element (pixel) into several groups and reading signals groupwise.

However, in the detector of the structure disclosed in PTL1, the image quality may deteriorate due to so-called crosstalk. In the structure of PTL1, neighboring detection strips of different groups are provided in one pixel. Thus, hot electrons or secondary radiations generated by radiations incident on a certain detection strip in a detection element may be incident on detection strips of another neighboring group, which may cause noise and contrast reduction.

### SUMMARY OF THE INVENTION

The present invention in its first aspect provides a radiation detection system comprising: at least one detector in which a plurality of detection elements are arranged, wherein each detection element includes a converting portion that converts energy of incident radiations directly into electrical signals and a signal reading portion that reads the electrical signal from the converting portion and outputs the electrical signal, the converting portion including a plurality of protruded portions arranged at intervals, and the plurality of protruded portions are electrically connected to one signal reading portion.

The present invention in its second aspect provides a radiation imaging apparatus comprising: a diffraction grating that diffracts X-rays to form an interference pattern; and the radiation detection system according to claim 1, wherein the intensity pattern is the interference pattern.

Further features of the present invention will become apparent from the following description of exemplary embodiments with reference to the attached drawings.

### BRIEF DESCRIPTION OF THE DRAWINGS

FIG. 1 is a schematic view for describing a structure of a detector;

FIGS. 2A to 2C are schematic views for describing a method of measuring an intensity pattern;

FIG. 3 is a schematic view for describing a detection system including a plurality of detectors;

FIG. 4 is a schematic view for describing a detection system including a detector moving mechanism;

FIG. 5 is a schematic view illustrating a radiation detecting portion having a planar structure;

FIGS. 6A and 6B are schematic views illustrating an incidence direction of radiations on a detector;

FIG. 7 is a schematic view illustrating a radiation detecting portion having a columnar structure;

FIG. 8 is a schematic view for describing a radiation imaging apparatus; and

FIG. 9 is a schematic view for describing a structure of a modification of a detector.

### DESCRIPTION OF THE EMBODIMENTS

Hereinafter, preferred embodiments of the present invention will be described in detail with reference to the accompanying drawings. In the drawings, the same members will be denoted by the same reference numerals, and redundant description thereof will not be provided.

A radiation detection system according to the present embodiment includes at least one detectors that detect radiations. A detection element included in the detector includes a converting portion (corresponding to the detection strip of PTL1) that converts radiation energy directly into electrical signals. Since the converting portion includes a plurality of protruded portions and the protruded portions are arranged at intervals, it is possible to further reduce crosstalk than PTL1. Due to this, it is possible to acquire radiation images having a periodic pattern with high resolution and high quality. This will be described in more detail below.

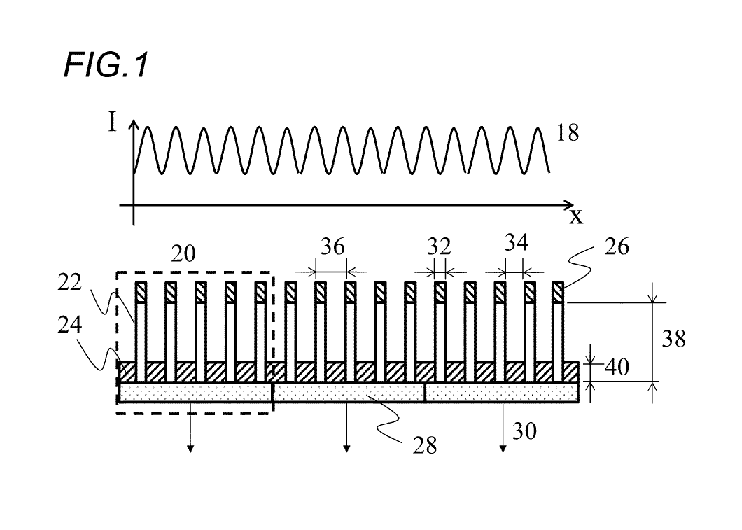

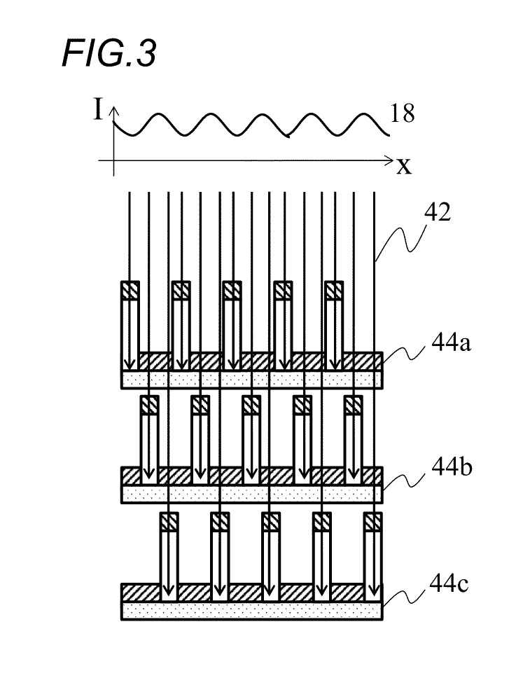

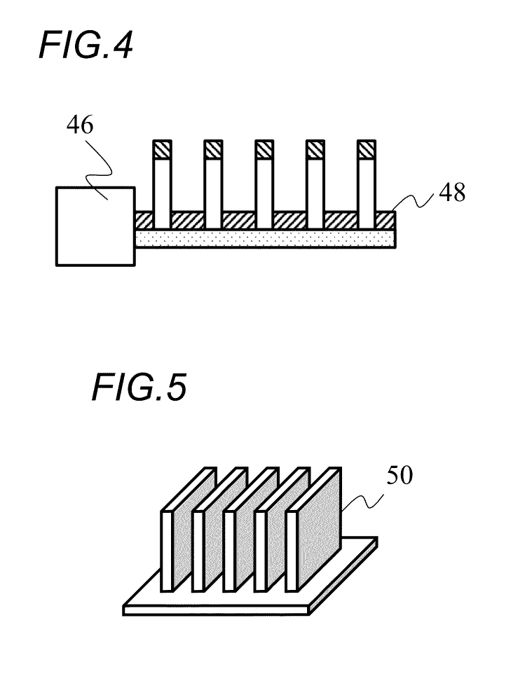

FIG. 1 is a schematic view for describing the structure of a detector of a radiation detection system of the present embodiment. The radiation detection system (hereinafter also referred to simply as a “detection system”) according to the present embodiment is an apparatus that detects an intensity pattern 18 of radiations spatially modulated at a certain period in at least one direction. The detection system includes at least one detectors in which a plurality of detection elements 20 are arranged. (A configuration in which the system includes a plurality of detectors and a configuration in which the system includes one detector will be described with reference to FIGS. 3 and 4, respectively.)

The plurality of detection elements 20 are arranged one-dimensionally or two-dimensionally in one detector. Respective detection elements 20 correspond to pixels (which are units of outputting a signal indicating detected radiation intensity). Although FIG. 1 illustrates a configuration in which three detection elements 20 are arranged one-dimensionally for the purpose of illustrating the structure, the number and the arrangement of the detection elements 20 are not limited to this. The length of one side of the detection element 20 (that is, a pixel size or the size of an effective detection area of the detection element 20 in a direction perpendicular to a radiation propagation direction) is larger than ½ of a spatial wavelength of the intensity pattern 18. The spatial wavelength of the intensity pattern 18 is the distance corresponding to one period of spatial modulation of the intensity pattern 18. In the example of FIG. 1, the pixel size corresponds to approximately five times the spatial wavelength of the intensity pattern 18. In conventional detectors, the limit measurable spatial frequency (resolution) is determined by a pixel size and it is not possible to reproduce a fine pattern having a spatial frequency exceeding the resolution. Thus, in the present embodiment, the structures of the individual detection elements 20 are modified so as to realize a detection system having higher apparent resolution than the pixel size.

As illustrated in FIG. 1, each detection element 20 includes a converting portion that converts the energy of incident radiations into electrical signals, an electrode portion 26 that applies voltage to the converting portion, and a signal reading portion 28 that reads the electrical signals from the converting portion and outputs the electrical signals. The converting portion is a so-called direct-conversion semiconductor that converts the energy of incident radiations directly into electrical signals. In the present invention and the present specification, converting the energy of incident radiations directly into electrical signals means converting the incident radiations into electrical signals without converting the same into ultra-violet rays or visible rays. When radiations are incident on the converting portion, electrons and holes are generated due to radioactive ray ionization. When voltage is applied to the electrode portion 26, an electric field is generated between the signal reading portion 28 and the electrode (that is, inside the converting portion), and electrons can be transported to the signal reading portion 28.

The converting portion includes a plurality of protruded portions arranged at intervals. The shapes and the arrangements of these protruded portions are designed such that respective protruded portions measure radiation intensities of the same phase portions of the intensity pattern 18. The intensity pattern 18 mentioned herein is an intensity pattern 18 which is not affected by a subject, and in the case of a Talbot interferometer, indicates an interference pattern obtained in a state where a subject is not disposed in an optical path. In the present embodiment, the converting portion includes a first region 22 having a first width 32 and a first thickness 38 and a second region 24 having a second width 34 and a second thickness 40. The second thickness 40 is smaller than the first thickness 38. That is, the first region 22 is formed so as to have a thickness (height) larger than that of the second region 24, whereby the first region 22 is formed as a protruded portion.

Radiations enter into the converting portion from the front surface to generate electrons and holes while consuming energy and being converted into electrical signals. When the converting portion is sufficiently thick, the radiations consume almost entire energy and are converted into large electrical signals. On the other hand, when the converting portion is thinner than a length that radiations can enter into, the radiations are scarcely converted into electrical signals but pass through the converting portion. Due to this, when radiations of the same intensity are incident, the thinner the converting portion, the smaller the amount of electrical signals converted.

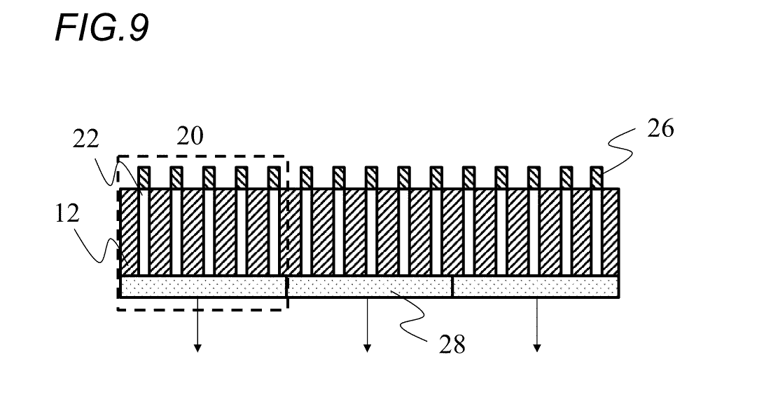

As illustrated in FIG. 1, when the first and second regions 22 and 24 have different thicknesses, the first region 22 can convert a larger amount of radiations into electrical signals. In order to increase a difference in the amounts of electrical signals obtained in the first and second regions 22 and 24, the first thickness 38 is preferably as large as possible and the second thickness 40 is preferably as small as possible. When maintaining the space between the first regions 22 or suppressing tilting of the first region 22, it is preferable that the first regions arranged in the line-and-space pattern be connected on the outer side of a detection region (a converting portion on the signal reading region 28 will be referred to as a detection region). A connecting portion that connects the first regions may be of the same material as that of the first region 22. Further, when the connecting portion that connects the first regions has a small width and an electrical signal generated at the connection portion is smaller than an electrical signal generated at the first region 22, the first regions may be connected on the inner side of the detection region. For instance, the first regions may have a mesh shape. Moreover, although the second thickness 40 is larger than 0 in the case of FIG. 1, the second thickness may be 0 as in a detector illustrated in FIG. 9. The detector illustrated in FIG. 9 has a spacer 12 instead of the second region 24. Although the spacer 12 may be formed from a material which substantially cannot convert the energy of radiations into electrical signals, a spacer 12 between the first regions disposed in different detection elements is preferably an insulator. When the spacer 12 between the first regions disposed in different detection elements is an insulator, it is possible to reduce crosstalk between the first regions connecting the detection elements. The spacer 12 is not necessary when the space between the first regions 22 can be maintained even if the spacer 12 is not provided (for example, when the first regions have the mesh shape or when the first regions arranged in the line-and-space pattern are connected on the outer side of the detection region). However, in order to maintain the space between the first regions 22 and suppress tilting of the first region 22, it is preferable to dispose the spacer 12 between the first regions. Moreover, although the material of the electrode portion 26 disposed in the first regions may adhere to the spacer during manufacturing, it is also possible to reduce the crosstalk if a portion of the spacer 12 is an insulator even in use of the space that is between the first regions disposed in different detection elements. As illustrated in FIG. 9, even when the spacer 12 is disposed between the first regions 22 and the thickness of the spacer is equal to or larger than the thickness 38 of the first region, since the spacer 12 is not the converting portion, the converting portion includes a plurality of protruded portions.

Moreover, the second width 34 (the space between two neighboring protruded portions) may be equal to or larger than the first width 32 (the width of the protruded portion in an arrangement direction of the protruded portions). That is, when the first region (protruded portions) are disposed periodically, the first width 32 may be equal to or smaller than ½ of the pitch of the first regions (protruded portions). When radiations are converted into electrical signals by the first regions 22, the electrical signals are obtained as the sum in all first regions 22. That is, even when the intensity of radiations incident within the first width 32 of the first region 22 in such a way that radiations incident on the right end of the first region 22 are incident on the left end of the first region 22, the radiation intensity within the width of the first region 22 is obtained as averaged electrical signals. Thus, there is no change in the obtained electrical signals. The fact that the first width 32 is small means that radiations in a narrower range than the period of the intensity pattern 18 can be converted into electrical signals. When electrical signals in a narrower range than the period of the intensity pattern 18 are obtained, the proportion of the averaged signals of the intensity pattern 18 decreases, and the effect of enhancing reproducibility of the intensity pattern 18 is exhibited (that is, the spatial resolution is improved).

Moreover, the arrangement direction and period of the plurality of protruded portions (the first regions 22) may be the same as the spatial modulation direction and period of the intensity pattern 18. Due to this, radiations at the same phase of the intensity pattern 18 are incident on all protruded portions (the first regions 22) in the detection element 20. The length (that is, the pitch of the protruded portions) corresponding to the sum of the first and second widths 32 and 34 may not be exactly the same as one wavelength of the spatial wavelength of the intensity pattern 18. In the plurality of protruded portions (the first regions 22) in one detector, deviation in the phases of the detected intensity distributions may be equal to or smaller than 1/10 of the period of the intensity pattern 18. Thus, an arrangement shift of the protruded portions (the arrangement shift is 0 when the arrangement period of the protruded portions is the same as the spatial wavelength of the intensity pattern 18) may be equal to or smaller than 1/10 of the pitch of the protruded portions.

When the arrangement direction and period of the plurality of protruded portions (the first regions 22) are set to be the same as the direction and period of the intensity pattern 18, at least the width (the first width 32) of the protruded portion may be set to be smaller than the space (the second width 34) between the protruded portions. That is, the width (the first width 32) of the protruded portion is set to be smaller than ½ of the spatial wavelength of the intensity pattern 18. In this way, it is possible to resolute the intensity pattern 18.

In the detection element 20 of the present embodiment, all the first and second regions 22 and 24 are physically and electrically connected within one detection element. Due to this, all protruded portions in one detection element 20 are electrically connected to one signal reading portion 28. Thus, the detector of the present embodiment acquires the sum of electrical signals generated by the radiations incident on the plurality of first regions 22 disposed in one detection element as the value of the electrical signal of the radiation intensity detected by the detection element.

In general, when radiations are incident on a converting portion to generate electrons and holes, hot electrons having energy proportional to the energy of the radiations are generated. Moreover, secondary radiations are generated by recombination of electrons and holes and by deflection of hot electrons. Hot electrons and secondary radiations have a spatially finite spreading distance. For example, when 15 keV radiations are incident into NaCl, the radiations spread by 6 μm. If the spreading distance of the hot electrons and the secondary radiations is larger than the space (the second width 34) between the protruded portions, hot electrons and secondary radiations emitted from one protruded portion are incident on other neighboring protruded portions to generate new electrical signals. As in the conventional detector, when regions for measuring different phases are provided so as to neighbor to each other in one pixel (detection element), these hot electrons and secondary radiations cause deterioration in the image quality such as noise or contrast reduction. In contrast, in the present embodiment, the radiation intensities of the same phase portions of the intensity pattern 18 are measured in all protruded portions (the first regions 22) in one detection element 20, and a signal obtained by summing the radiation intensities is read by one signal reading portion 28. That is, only the signal of a specific phase range of the intensity pattern 18 is obtained from one detection element (pixel) 20. Thus, even when crosstalk occurs between protruded portions, since the electrical signals generated in respective protruded portions are summed, the crosstalk between protruded portions does not cause any problem. Therefore, deterioration in the image quality resulting from hot electrons and secondary radiations, which was issues in the conventional detector, is suppressed, and high-quality images can be obtained. Although the influence of spreading of radiations between neighboring detection elements 20 is exhibited, this spreading has a small effect on images.

As described above, the use of the detector having the structure illustrated in FIG. 1 enables the intensity information of the radiations at a specific phase of the intensity pattern 18 to be measured with high resolution and quality.

In the converting portion, the pressure of the space between the protruded portions (the first region 22) may be preferably smaller than the atmospheric pressure. It is preferable from the detection efficiency of radiations that hot electrons and secondary radiations emitted from one of the first regions 22 in the detection element 20 are absorbed in the other first region 22 without decaying. In general, an electron mean free path in air at 1 atmospheric pressure is approximately 0.5 μm. When the second width 34 is larger than the electron mean free path, an hot electron may collide with air while moving from one of the first regions 22 to reach the other first region 22 and the energy may be lost. By setting the pressure of the space between the first regions 22 to be lower than 1 atmospheric pressure, it is possible to reduce loss of the energy of hot electrons and to improve the radiations detection efficiency. As an example of the pressure, when the second width 34 is 2.5 μm, since the pressure of the space between the first regions 22 is set to 0.1 atmospheric pressure and the electron mean free path is approximately 5 μm, it is possible to reduce the loss dramatically.

In the converting portion, the width (first width 32) of the protruded portion may be preferably 1/n times the spatial wavelength of the intensity pattern 18, and the space (the second width 34) of the protruded portions may be (n−1)/n times the spatial wavelength of the intensity pattern 18. Here, n is an integer of 3 or more. This configuration means that the period of the intensity pattern 18 is divided by n (that is, divided by 3 or more) and measurements are performed, which is ideal for reproducing the intensity pattern 18.

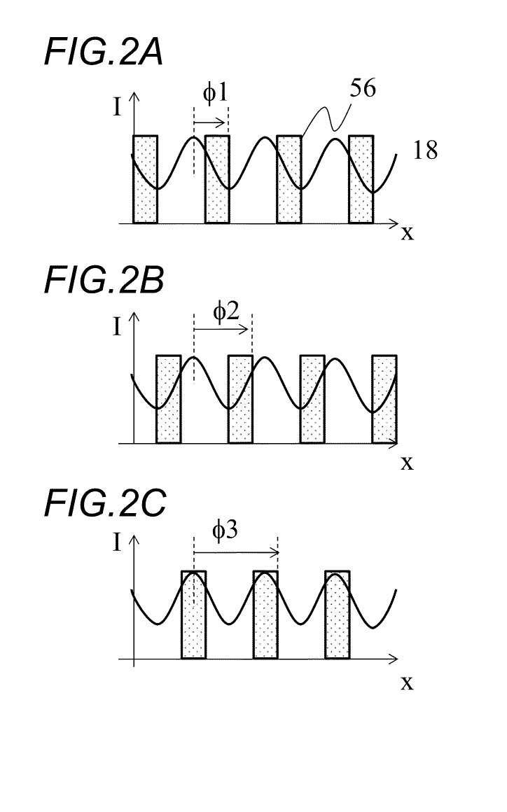

For example, as illustrated in FIGS. 2A to 2C, when the first width 32 is ⅓ of the period of the intensity pattern 18, the first region 22 detects a detection region 56 at a specific phase of the intensity pattern 18. As illustrated in FIGS. 2A to 2C, the intensity pattern 18 is measured at positions where the detection region 56 and the intensity pattern 18 have phase relations of φ1, φ2, and φ3. Here, φ2=φ1+2π/3, and φ3=0φ1+4π/3. By combining the signals measured at respective phases, it is possible to obtain the entire information of the intensity pattern 18.

The radiation detection system is configured by n pieces of detectors, whereby the system can detect the intensity pattern 18 without incurring loss of radiations. In this case, n pieces of detectors may be arranged along the propagation direction (transmission direction) of radiations, and the arrangement periods of the protruded portions of the respective detectors may have different phases so that the respective detectors measure radiation intensities of different phase portions of the intensity pattern 18. This will be described with reference to FIG. 3. Radiations 42 incident on the second regions 24 among the radiations 42 incident on a detector 44a are not detected but pass through the detector 44a. Thus, another detector 44b is provided on the downstream side (the back side of the detector 44a) of the propagation direction of the radiations 42, and the detectors are arranged so that a phase difference between the arrangement period of the detector and the intensity pattern 18 of the radiations 42 is different between the detectors 44a and 44b. For example, the detectors 44a and 44b are arranged so that the radiations 42 having passed through the second regions 24 (the gaps between protruded portions) of the detector 44a are incident on the first regions 22 of the detector 44b. In this way, the radiations 42 which have not be detected by the detector 44a can be detected by the detector 44b. Further, for example, when the first width is ⅓ of the period of the intensity pattern 18 (n=3), three detectors 44a, 44b, and 44c are arranged so that the detectors are at positions where the detectors and the intensity pattern 18 have phase relations of φ1, φ2=φ1+2π/3, and φ3=φ1+4π/3. By doing so, as illustrated in FIG. 3, a detection system capable of obtaining the signals of three different phases of the intensity pattern 18 by one measurement is obtained. In this case, it is preferable that the second thickness 40 is as small as possible. By doing so, it is possible to increase the signal ratios of the first and second regions 22 and 24 and to increase the amount of radiations 42 having passed through the regions.

Moreover, as illustrated in FIG. 4, the radiation detection system may include a moving mechanism 46 that moves a detector 48 in an arrangement direction (the lateral direction of the drawing) of protruded portions. In this way, it is possible to reduce the number of detectors and to reduce the cost. Moreover, the moving distance that the moving mechanism 46 moves the detector each time may be 1/n times the spatial wavelength of the intensity pattern 18. For example, the moving distance is set to ⅓ of the period of the intensity pattern 18 using the detector 48 of which the first width 32 is ⅓ of the period of the intensity pattern 18. In this way, as illustrated in FIGS. 2A to 2C, a detection system capable of obtaining the signals of three different phases of the intensity pattern 18 by three measurements is obtained.

The shape, structure, and arrangement of the protruded portions (the first regions 22) are optional. For example, as shown in FIG. 5 a structure in which a plurality of planar (strip-like) protruded portions are arranged in parallel (this structure is referred to as a one-dimensional converting portion 50) may be used. This structure is ideal in particular when the intensity pattern 18 has a period in one spatial direction only (that is, when measuring an intensity pattern based on one-dimensional periodic modulation). Since hot electrons and secondary radiations generated by radiations spread three-dimensionally, when there is only one periodic direction in which voids occur, it is possible to improve the radioactive ray detection efficiency.

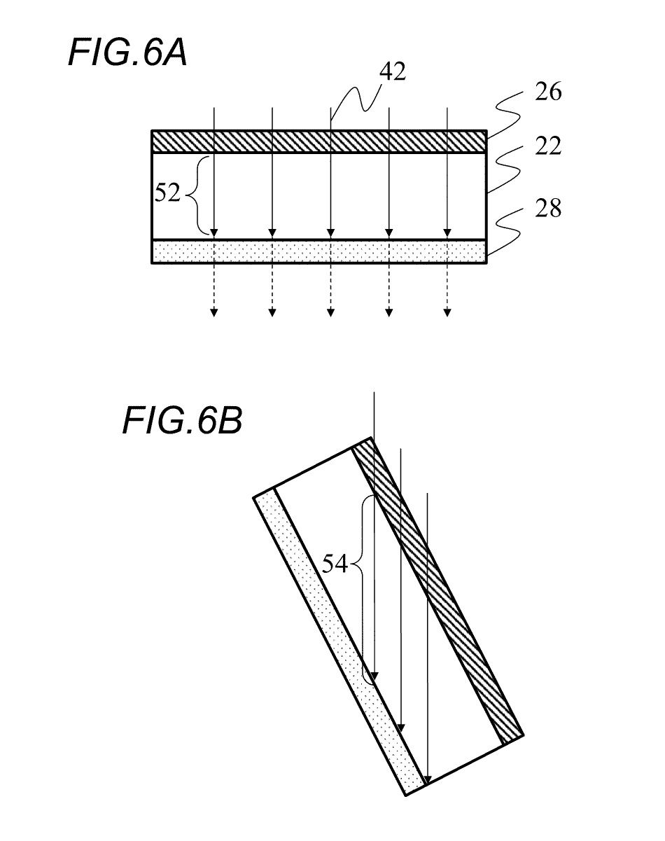

Moreover, as illustrated in FIG. 6B, a detector may be disposed so that an incidence direction of radiations 42 is vertical to an arrangement direction of protruded portions and is oblique to a height direction (a thickness direction or a normal direction of the detection element 20) of the protruded portions. Since radiations are incident obliquely, the distance 54 that the radiations 42 pass through the protruded portions is larger than the distance 52 (see FIG. 6A) when the radiations are incident vertically. When the energy of the radiations 42 is large, an interacting cross-sectional area of radiations and atoms decreases. Thus the longer the interacting distance, the higher the conversion efficiency.

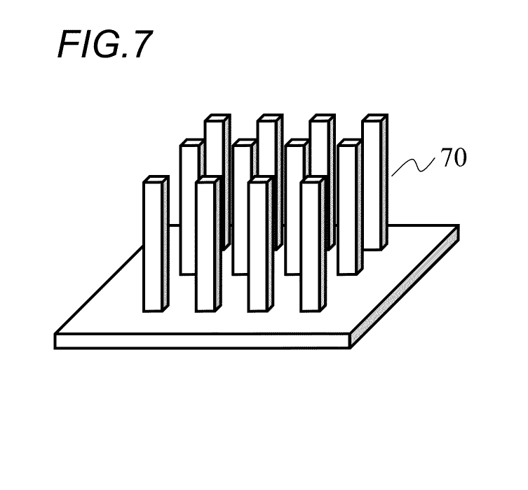

Moreover, in the radiation detector, the plurality of protruded portions (the first regions 22) in each detection element 20 may be arranged periodically in relation to at least two directions. For example, the intensity pattern 18 may have a periodic structure (that is, a two-dimensional periodic structure) in two orthogonal directions. In this case, the planar (strip-like) one-dimensional converting portion 50 as illustrated in FIG. 5 can obtain the information in one periodic direction only. Thus, even when a detection system including a plurality of detectors as illustrated in FIG. 3 is used, it is necessary to perform measurement in two periodic directions. Thus, the use of a detector having columnar two-dimensional converting portions 70 as illustrated in FIG. 7 enables the intensity pattern 18 having a two-dimensional periodic structure to be detected efficiently. The periods of two directions may be different.

The converting portions can be manufactured using a method of manufacturing a grating. For example, the converting portions as illustrated in FIG. 1 can be manufactured by patterning a substrate of a material that converts the energy of incident radiations directly into electrical signals using an etching mask by photolithography, and then, etching the substrate. Silicon is an example of the material which is easy to process by photolithography and etching and which converts energy of incident radiations directly into electrical signals. In an X-ray Talbot interferometer, a phase grating formed from silicon is often used as a diffraction grating, and converting portions formed from silicon can be manufactured similarly to a phase grating formed from silicon. Moreover, when a silicon wafer is used as a substrate, converting portions can be manufactured using semiconductor processing techniques.

Further, when the spacer 12 is disposed in the gap of the first regions as illustrated in FIG. 9, a material that converts the energy of incident radiations directly into electrical signals is processed into a thin sheet form, and the spacer materials are stacked alternately, whereby the converting portions can be manufactured. In this case, the stacking direction is the periodic direction of the first regions. The electrode portion 26 and the signal reading portion 28 are the same as the electrode portion and the signal reading portion of a general direct-conversion radiation detector and can be manufactured using the method of manufacturing the electrode portion and the signal reading portion of the general direct-conversion radiation detector.

### Practice Example

A specific example of a radiation imaging apparatus which uses the radiation detection system according to the embodiment of the present invention will be described.

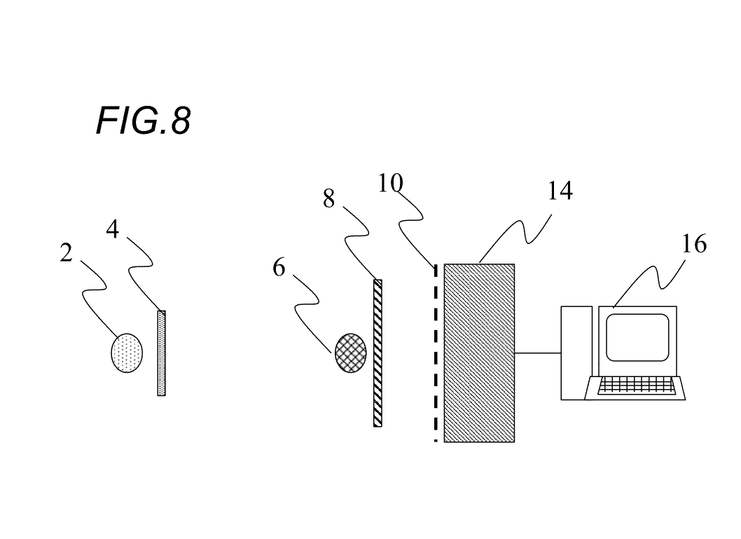

As illustrated in FIG. 8, in this practical example, the radiation detection system is used as a radiation detector of a radiation imaging apparatus which uses a Talbot interferometer. That is, the radiation imaging apparatus of this practical example generally includes a Talbot interferometer, a detection system 14, and a computing apparatus (image processing apparatus) 16.

A Talbot interferometer is an interferometer of such a type that observes an interference pattern 10 (also referred to as a self-image) formed when radiations having passed through a subject 6 are diffracted by a diffraction grating 8. Since the interference pattern 10 is deformed due to a wave front distortion of the radiations having passed through the subject 6, it is possible to obtain phase information of the subject 6 by analyzing the image of the distortion of the interference pattern 10 observed by the radiation detection system 14. In this practical example, a method arranging a source grating 4 between the radiation source 2 and the subject 6 to convert the radiation source 2 into a number of linear or dot-shaped small radiation sources is employed. With this method, the non-coherent radiation source 2 can be used as a light source. A configuration which uses the light source made up of the radiation source 2 and the radiation source grating 4 is referred to as a Talbot-Lau interferometer.

The radiation source 2 includes a molybdenum target capable of generating characteristic X-rays having the energy 17.5 keV. The X-rays used in the Talbot interferometer may be monochromatic with a sharp spectrum like characteristic X-rays, and may be polychromatic with a broad spectrum like bremsstrahlung X-rays. The source grating 4 has a strip-like structure and a grating having a pitch of 24 μm and an opening width of 10 μm is used. The diffraction grating 8 used is a phase grating in which two regions having a phase modulation difference of π/2 are arranged alternately. The diffraction grating 8 has a period of 6.14 μm. The source grating 4, the diffraction grating 8, and the detection system 14 are provided in that order from the radiation source 2 in the radiation direction (propagation direction) of X-rays. The distance between the source grating 4 and the diffraction grating 8 is 1000 mm and the distance between the diffraction grating 8 and the detection system 14 is 357 mm. With this arrangement, the interference patterns 10 generated by the X-rays passing from the respective openings of the source grating 4 are strengthened. Since the intensity of the interference pattern 10 becomes the highest in a plane where the distance from the diffraction grating 8 is identical to the Talbot length, the distance between the diffraction grating 8 and the detection system 14 may be made identical to the Talbot length. However, since the interference pattern 10 has high contrast if the distance is close to the Talbot length, the position of the detection system 14 may be slightly deviate from the Talbot length.

As illustrated in FIG. 3, the detection system 14 has a structure in which a plurality of (three) detectors 44a, 44b, and 44c are arranged (superimposed) along the propagation direction (transmission direction) of radiations. As illustrated in FIG. 5, each detector is a detector including a one-dimensional converting portion (that is, a structure in which a plurality of planar protruded portions is arranged in one direction (the lateral direction of FIG. 5)). The three detectors 44a, 44b, and 44c have the same structure, and the first width 32 is 2.75 μm and the second width 34 is 16.48 μm. Moreover, the thickness in a direction perpendicular to the plane of the detectors 44a to 44c is 500 μm. A semiconductor detector formed from silicon, for example, may be used as the converting portion. The electrode portion 26 is provided above the first region 22. The signal reading portion 28 may be a complementary metal oxide semiconductor or a thin film transistor.

As illustrated in FIG. 6B, the detectors 44a to 44c are tilted in relation to the propagation direction of radiations. When the tilt angle (the angle between the propagation direction of the radiations and the base surface of the converting portion) is 6°, the propagation distance of the radiations can be 10 times that of perpendicular incidence. The reference positions (for example, the pixels at the center) of the respective detectors 44a to 44c are positioned on the optical axis of the same radioactive ray, and the periodic directions of the respective detectors 44a to 44c are identical.

The computing apparatus 16 is a system that provides functions of processing image data obtained as the output (the intensity pattern of radiations) of the detection system 14 to generate observation and diagnosis images and extracting feature amounts (image information) useful for inspection, diagnosis, and the like. Moreover, the computing apparatus 16 also provides a function of outputting image processing results to a display device. The computing apparatus 16 can be configured by installing a program for realizing the functions into a general-purpose computer system, for example.

The radiation imaging apparatus operates as follows. First, the interference pattern 10 is imaged in a state where the subject 6 is not present. The signals of the detectors 44a, 44b, and 44c are combined to obtain the intensity pattern 18 in the state where the subject 6 is not present. Subsequently, the subject 6 is disposed and the intensity pattern 18 is obtained in the same manner. Using the computing apparatus 16, an absorption amount, a phase shift, and a scattering amount of the subject 6 are calculated for each detection pixel from a change in the amplitude, phase, and visibility of pattern of the intensity pattern 18 changing depending on the presence of the subject 6 to obtain respective maps thereof as images.

According to the radiation detection system having the above-described configuration, it is possible to acquire a radiation image having a periodic pattern with high resolution and quality. Thus, since the intensity pattern having a smaller period than the pixel size can be directly detected without using an analyzer grating or the like, it is possible to realize a high-performance radiation imaging apparatus at a low cost.

The present invention is not limited to the above-described configuration, and various modifications and changes can occur without departing from the spirit thereof. For example, although the Talbot-Lau interferometer has been illustrated in the practical example, the radiation detection system of the present invention may be combined with other apparatuses. That is, the radiation detection system of the present invention can measure radiation images having a periodic pattern and can measure an interference pattern according to another method without limiting to an interference pattern according to the Talbot interferometry. Moreover, besides the interference pattern, the present invention can be applied to measurement of periodic patterns generated by other optical means and digital signal processing. Further, in the present invention and the present specification, the radiation imaging apparatus is an apparatus that detects an intensity distribution of an image (an interference pattern in the practical example) formed by radiations. That is, the radiation imaging apparatus is not limited to an apparatus that acquire an image of a subject.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-234138, filed on Nov. 12, 2013, and Japanese patent Application No. 2014-214576, filed on Oct. 21, 2014, which are hereby incorporated by reference herein in their entirety.

What is claimed is:

1. A radiation detection system comprising:
at least one detector in which a plurality of detection elements are arranged, wherein
each detection element includes a converting portion that converts energy of incident radiations directly into electrical signals and a signal reading portion that reads the electrical signal from the converting portion and outputs the electrical signal, the converting portion including a plurality of protruded portions arranged at intervals, and
the plurality of protruded portions are electrically connected to one signal reading portion.

2. The radiation detection system according to claim 1, wherein
the signal reading portion reads a sum of the electrical signals converted by the plurality of protruded portions.

3. The radiation detection system according to claim 1, wherein
the radiation detection system detects a periodic intensity pattern of radiations, and
the plurality of protruded portions are arranged so that respective protruded portions measure radiation intensities of the same phase portion of the intensity pattern.

4. The radiation detection system according to claim 1, wherein
the radiation detection system detects a periodic intensity pattern of radiations, and
the plurality of protruded portions are arranged in the same direction and period as the direction and period of spatial modulation of the intensity pattern.

5. The radiation detection system according to claim 1, wherein
a width of the protruded portion in an arrangement direction of the protruded portions is smaller than a space between two adjacent protruded portions in the arrangement direction of the protruded portions.

6. The radiation detection system according to claim 3, wherein
a width of the protruded portion in an arrangement direction of the protruded portions is smaller than ½ of a distance corresponding to one period of spatial modulation of the intensity pattern.

7. The radiation detection system according to claim 1, wherein
the radiation detection system detects a periodic intensity pattern of radiations, and
a width of the protruded portion in an arrangement direction of the protruded portions is 1/n (n is an integer of 3 or more) of a distance corresponding to one period of spatial modulation of the intensity pattern, and
a space between two adjacent protruded portions in the arrangement direction of the protruded portions is (n−1)/n of the distance corresponding to one period of spatial modulation of the intensity pattern.

8. The radiation detection system according to claim 1, wherein
a pressure of a space between two adjacent protruded portions is lower than atmospheric pressure.

9. The radiation detection system according to claim 1, wherein
an interference pattern formed by interference of radiations having passed through a diffraction grating is detected.

10. The radiation detection system according to claim 1, wherein
the converting portion is a member having a structure in which a plurality of first regions having a first thickness and a plurality of second regions having a second thickness smaller than the first thickness are arranged alternately, and portions of the first regions correspond to the protruded portions.

11. The radiation detection system according to claim 1, wherein
an insulator is disposed in a gap between the plurality of protruded portions.

12. The radiation detection system according to claim 1, wherein
a plurality of detectors are arranged in a propagation direction of radiations, and
the plurality of detectors are arranged so that periodic arrangements of the protruded portions have different phases.

13. The radiation detection system according to claim 12, wherein
the plurality of detectors include a first detector and a second detector disposed closer to a downstream side of the propagation direction of radiations than the first detector, and
the second detector detects radiations having passed through gaps between the plurality of protruded portions of the first detector.

14. The radiation detection system according to claim 12, wherein
the radiation detection system detects a periodic intensity pattern of radiations,
a width of the protruded portion in an arrangement direction of the protruded portions is 1/n (n is an integer of 3 or more) of a distance corresponding to one period of spatial modulation of the intensity pattern, and
n pieces of detectors are arranged so that the phases of periodic arrangements of the protruded portions are shifted by 2π/3.

15. The radiation detection system according to claim 1, further comprising:
a moving mechanism that moves the detector in an arrangement direction of the protruded portions.

16. The radiation detection system according to claim 15, wherein
the radiation detection system detects a periodic intensity pattern of radiations,
a width of the protruded portion in the arrangement direction of the protruded portions is 1/n (n is an integer of 3 or more) of a distance corresponding to one period of spatial modulation of the intensity pattern, and
a moving distance that the moving mechanism moves the detector each time is 1/n of the distance corresponding to one period of spatial modulation of the intensity pattern.

17. The radiation detection system according to claim 1, wherein
the plurality of protruded portions have a structure in which a plurality of planar protruded portions are arranged in parallel, and
radiations are incident on the planar protruded portions in a direction vertical to an arrangement direction of the planar protruded portions and oblique to a height direction of the planar protruded portions.

18. The radiation detection system according to claim 1, wherein
the plurality of protruded portions are arranged periodically in at least two directions.

19. A radiation imaging apparatus comprising:
a diffraction grating that diffracts X-rays to form an interference pattern; and
the radiation detection system according to claim 1, wherein
the intensity pattern is the interference pattern.

20. The radiation imaging apparatus according to claim 19, further comprising:
a computing apparatus that processes an image of the intensity pattern of radiations acquired by the radiation detection system.
